(19) United States
(12) Patent Application Publication
(10) Pub. No.: US 2009/0086754 A1
(43) Pub. Date: Apr. 2, 2009

(54) Content Aware Connection Transport

(75) Inventors: T. Benjamin MACK-CRANE, Downers Grove, IL (US); Lucy YONG, Tulsa, OK (US); Linda DUNBAR, Plano, TX (US)

Correspondence Address: CONLEY ROSE, P.C., 5601 GRANITE PARKWAY, SUITE 750, PLANO, TX, 75024, US

(73) Assignee: Futurewei Technologies, Inc., Plano, TX (US)

(21) Appl. No.: 11/970,283

(22) Filed: Jan. 7, 2008

Related U.S. Application Data
(60) Provisional application No. 60/976,857, filed on Oct. 2, 2007.

(51) Int. Cl. H04J 3/16

(52) U.S. Cl. 370/466; 370/465

(57) ABSTRACT

A network comprising an ingress layer processor (LP) coupled to a connection carrying a composite communication comprising a plurality of component communications, a composite connection coupled to the ingress LP and comprising a plurality of parallel component connections, wherein the composite connection is configured to transport the component communications using the component connections, and an egress LP coupled to the composite connection and configured to transmit the composite communication at a connection point. Also disclosed is a network component comprising at least one processor configured to implement a method comprising receiving a connection carrying a plurality of component communications, reading a communication distinguishing fixed point (CDFP) from at least some of the component communications, and accessing a table associating at least some of the CDFPs with at least one component connection.

### CROSS-REFERENCE TO RELATED APPLICATIONS

This application claims priority to U.S. Provisional Patent Application Ser. No. 60/976,857 filed Oct. 2, 2007 by Mack-Crane, et al. and entitled, “System and Method for Content Aware Connection Transport,” which is incorporated by reference herein as if reproduced in its entirety.

This application is related to U.S. patent application Ser. No. 11/769,534 filed Jun. 27, 2007 by Yong, et al. and entitled, “Network Availability Enhancement Technique in Packet Transport Networks,” which is incorporated by reference herein as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Various connection transport technologies have been developed in standards and deployed in networks. Examples of these connection transport technologies include time division multiplexed (TDM) circuits, such as Synchronous Digital Hierarchy (SDH) and Plesiochronous Digital Hierarchy (PDH), and packet virtual circuits, such as Frame Relay and X.25. Generally, these technologies create a connection comprising a single transport channel extending between two points in the network. Specifically, the connection is a series of links providing a single path to carry the client packets. The client packets are transported along the connection such that the packets received at the ingress port are delivered to the egress port in the same order as received at the ingress port. In addition, the connection transports these packets without any visibility into or knowledge of the packets' contents.

Traffic engineering enables service providers to optimize the use of network resources while maintaining service guarantees. Traffic engineering becomes increasingly important as service providers desire to offer transport services with performance or throughput guarantees. The single path nature of traditional connections limits the ability of the network operator to engineer the traffic in the network. Specifically, traffic engineering activities may be limited to the placement of large capacity edge-to-edge tunnels, which limits the network operator's flexibility. Additional flexibility may be obtained by creating additional tunnels and using additional client layer functions to map client traffic to these tunnels. This may further require each tunnel's primary and backup route to be reserved and engineered from edge to edge. Such a configuration makes link capacity optimization awkward and complex.

### SUMMARY

In one aspect, the disclosure includes a network comprising an ingress layer processor (LP) coupled to a connection carrying a composite communication comprising a plurality of component communications, a composite connection coupled to the ingress LP and comprising a plurality of parallel component connections, wherein the composite connection is configured to transport the component communications using the component connections, and an egress LP coupled to the composite connection and configured to transmit the composite communication at a connection point.

In another aspect, the disclosure includes a network component comprising at least one processor configured to implement a method comprising receiving a connection carrying a plurality of component communications, reading a communications distinguishing fixed point (CDFP) from at least some of the component communications, and accessing a table associating at least some of the CDFPs with at least one component connection.

In yet another aspect, the disclosure includes a method comprising receiving a connection carrying a composite communication comprising a plurality of component communications comprising a plurality of packets, interpreting information encoded in the packets, and promoting the transmission of the composite communication on a composite connection comprising a plurality of parallel component connections, wherein the component communications are transported on the component connections such that the order of packets in each component communication is maintained, and wherein the composite communication is transported on the composite connection such that the order of packets belonging to different component communications in the composite communications is not necessarily maintained.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1A is a schematic diagram of an embodiment of a content aware connection transport system.

FIG. 1B is a schematic diagram of another embodiment of a content aware connection transport system.

FIG. 1C is a schematic diagram of another embodiment of a content aware connection transport system.

FIG. 2 is an illustration of an embodiment of a component communications mapping table.

FIG. 3 is a flowchart of one embodiment of a composite connection ingress process.

FIG. 4 is a flowchart of one embodiment of a composite connection egress process.

FIG. 5 is a schematic diagram of one embodiment of a general-purpose computer system.

### DETAILED DESCRIPTION

It should be understood at the outset that, although an illustrative implementation of one or more embodiments are provided below, the disclosed systems, methods, or both may be implemented using any number of techniques, whether currently known or in existence. The disclosure should in no way be limited to the illustrative implementations, drawings, and techniques illustrated below, including the examples of designs and implementations illustrated and described herein, but may be modified within the scope of the appended claims along with their full scope of equivalents.

Disclosed herein is a content aware connection transport network. The content aware connection transport network comprises an ingress LP coupled to an egress LP via at least one composite connection. The composite connection comprises a plurality of parallel component connections such that packets may be transported from the ingress LP to the egress LP via any one of the component connections. Upon receiving a packet on a connection carrying a composite communication comprising a plurality of packets, the ingress LP reads a CDFP from the packet, uses a Component Communications Mapping (CCM) table to determine the component connection associated with the CDFP, and transports the packet to the egress LP using the component connection associated with the CDFP. The CCM table is configured such that each component communication within the composite communication is transported along a single component connection, thereby preserving the packet order within the component communication. However, the total order of packets belonging to the composite communication is not necessarily preserved as the composite communication is transported through the network. Upon receipt of the packets from the various component connections, the egress LP reassembles the composite communication and transmits the composite communication on an egress connection port. By employing such a configuration, the content aware connection transport network may allow the composite communication to be traffic engineered across a network or a portion of a network without adding any additional client functions or managing multiple independent network connections.

The content aware connection transport network described herein implements many types of connections. As used herein, a “connection” is a transport channel that has an ingress point and at least one egress point, wherein packets received at the ingress point are transported to all the egress points. A connection may be a single link connection or may be a path that traverses several links and nodes (a serial compound link connection). The connection may be implemented using switching functions to provision port-to-port mappings between the various links or paths. Generally, the packets that are transported along the connection follow the same path through the network such that each packet traverses the same links along the path from the ingress point to each egress point. However, an exception may exist in cases where the connection comprises a plurality of parallel link connections or component connections. Such is the case with the composite connection described herein.

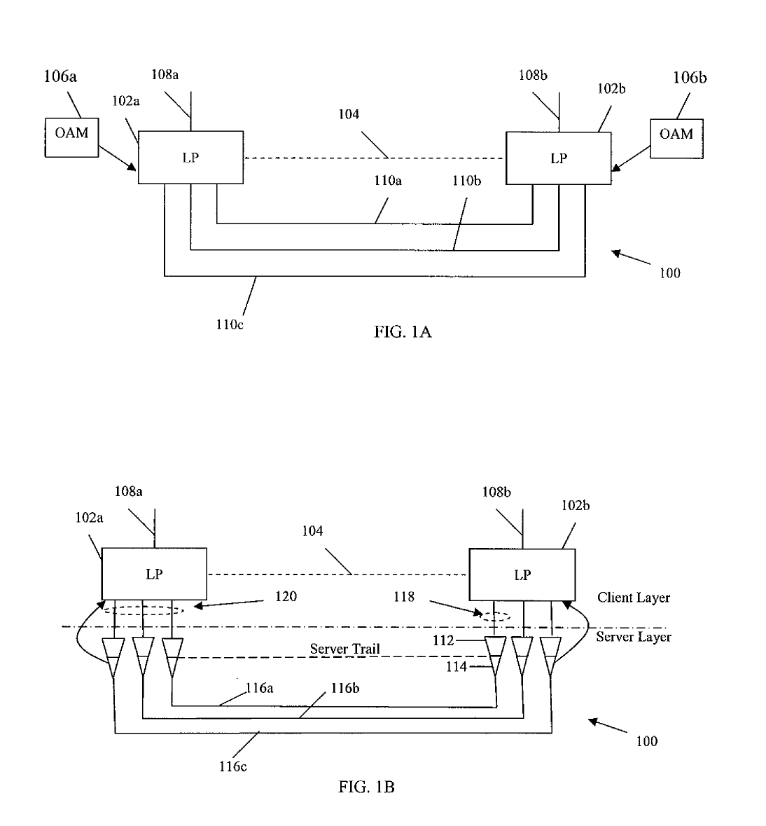

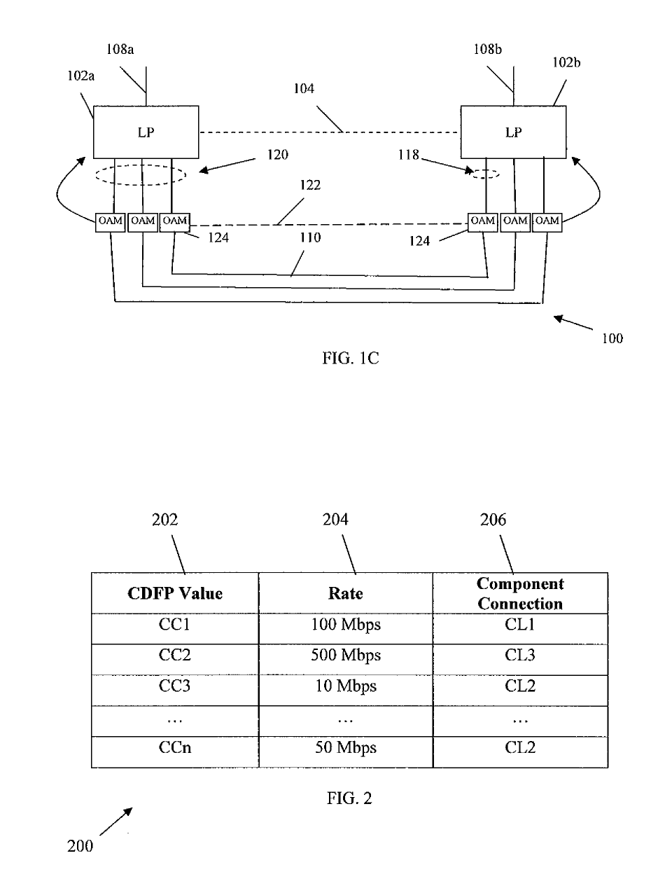

FIG. 1A is a schematic diagram of an embodiment of a content aware connection transport network 100. The network 100 comprises an ingress LP 102a and an egress LP 102b (collectively, 102) coupled to each other via a composite connection 104. The ingress LP 102a is configured to receive a connection carrying a composite communication comprising a plurality of component communications on an ingress connection port 108a, and transport the composite communication to the egress LP 102b using the composite connection 104. Although the network 100 may view the composite connection 104 as a single connection, the composite connection 104 may comprise a plurality of parallel component connections 110a, 110b, and 110c (collectively, 110). Thus, the ingress LP 102a may distribute the composite communication across the various component connections 110. The component connections 110 transport the component communications to the egress LP 102b, where the component communications are recombined into the composite communication, which is transmitted on an egress connection port 108b. If desired, the network 100 may also comprise operation, administration, and maintenance (OAM) modules 106a and 106b (collectively, 106) coupled to the ingress and egress LPs 102, which may be configured to monitor the status of the component connections 110.

The LPs 102 are processors or functionality that exist at the ingress and egress of the composite connection 104. Specifically, the LP 102 may be a part of any device, component, or node that may produce, transport, and/or receive connections carrying composite communications, for example, from connection ports 108 or from other nodes. Typically, the LPs 102 will be implemented at the edge nodes within a network, but the LPs 102 may also be implemented at other locations as well. In some embodiments, the LPs 102 may be functionality built into an existing forwarding function, such as a switching fabric within the network 100. As described below, the LPs 102 may distribute the packets in the composite communication over the composite connection 104 based on the CDFP in the packets. This enables the LPs 102 to distribute packets across multiple resources or queues, e.g. the component connections 110, thereby enabling traffic engineering without reordering packets belonging to any component communication or adding any additional information to the packets. The LPs 102 may be part of a packet transport node such as those contained in a multi-protocol label switching MPLS) network, an Institute of Electrical and Electronic Engineers (IEEE) 802.1 provider backbone bridged-traffic engineered (PBB-TE) network, or other connection-oriented packet networks. Alternatively, the LPs 102 may reside on customer premise equipment (CPE) such as packet voice PBX, video service platform, and Web server.

The composite connection 104 may be distinguished from the component connections 110 by the order of the data that they carry. Specifically, the term “composite connection” refers to a virtual connection between two points that is configured to transport the composite communication using a specified bandwidth or quality of service (QoS), but that does not necessarily transport the packets within the composite communication along the same path or route. In contrast, the term “component connection” refers to one of a plurality of parallel links, connections, paths, or routes within a composite connection that preserves the order of packets transported therein. The component connections 110 are sometimes referred to as component link connections, and specifically include individual link connections and serial compound link connections. The composite connection 104 may include maintenance points modeled as a sub-layer function that terminates at the LPs 102. These maintenance points may generate or receive maintenance messages over the component connections 110, which may be filtered to the maintenance termination points.

In an embodiment, there may be multiple layers of composite connections 104. For example, a composite connection 104 may comprise a plurality of component connections 110, one of which traverses a second composite connection, which itself comprises a plurality of component connections 110. For example, the second composite connection may be an aggregated link at some point along the path of one component connection in the first composite connection. In such a case, the composite communication carried by the second composite connection may be distributed across the various parallel links and reassembled for further transport along the component connection belonging to the first composite connection.

Connections carrying composite communications are received from or transmitted to other networks or entities via the client ports 108. As used herein, the term “connection port” refers to an ingress or egress into a network comprising a composite connection upon which a composite communication is sent or received. The connection port 108 may be a connection as defined herein, or may simply be a port or other component coupling the network 100 to another network or entity. While the network 100 may comprise a single ingress connection port 108a and a single egress connection port 108b as shown in FIG. 1A, the network 100 may also comprise a plurality of ingress and egress connection ports 108 coupled to LPs 102. In such a case, each composite connection may be associated with one pair of ingress and egress connection ports 108.

The composite communication may be any set of packets or messages that needs to be transported across the network. Specifically, the term “composite communication” refers to a data stream that is received by a network in a specified order and that is transmitted from the network in some order, but that need not maintain the specified order that is received. The composite communication is typically associated with a service level agreement (SLA) that specifies a minimum transport capacity, QoS, or other criteria for transporting the component communications whose packet order is to be maintained through the network. For example, the composite communication may be stream of Ethernet packets, wherein the QoS is specified within the header of the packet or frame.

The composite communication comprises a plurality of component communications. Specifically, the term “component communication” refers to a plurality of packets that are associated with each other. The component communication may be a subset of a composite communication, and the packets within a component communication may have a substantially identical CDFP or will otherwise be identified as belonging to the same component communication. When a component communication is transported along a component connection 110, the component communication will maintain its order as it is transported across the network 100.

The packets in the composite communication may contain a CDFP. As used herein, the term “CDFP” refers to information in the packet that associates the packet with other packets in a component communication. The CDFP may be a fixed point in the packets in that its value and position is the same for any packet in a given component communication. Examples of CDFPs include communication identifiers, service instance identifiers, sender and receiver identifiers, traffic class identifiers, packet QoS level identifiers, packet type identifiers, Internet Protocol version 6 (IPv6) flow labels, and other such information in the packet header. One specific example of a CDFP is the MPLS pseudowire inner label, which identifies each client pseudowire within an outer tunnel (connection) used for transport. Another specific example of a CDFP is an Ethernet backbone service instance identifier (I-SID)), which identifies the individual service instances carried over a backbone tunnel or VLAN. The CDFP may also be client-encoded information. In such cases, the client information format may need to be known. For example, if the network is an Ethernet transport network and it is known that the client is always Internet Protocol (IP), then the CDFP may include the IP source and destination addresses, thereby distinguishing finer granularity component communications. In an embodiment, the CDFP is included in the packets when the packets enter the network such that the network components described herein do not have to add the CDFP to the packets. Alternatively, the LP 102 can add the CDFPs to the packets upon entry into the network 100, and remove the CDFPs from the packets prior to exit from the network 100.

The network 100 may also comprise an OAM module 106. The OAM module 106 may monitor the connectivity, performance, or both of the various connections and links within the network 100, and may do so at any of the composite connection points, component connection points, or both. The OAM module 106 may detect a full or partial fault in the composite connection 104, the component connections 110, or both. The OAM module 106 may also communicate the state of the component connections 110 to the LPs 102.

FIG. 1B illustrates another embodiment of the network 100 where the component connections 110 are provided by server trails. As shown, the composite connection 104 may comprise a plurality of adaptation functions 112, termination functions 114, and server layer network connections 116a, 116b, and 116c (collectively, 116). The adaptation functions 112 convert the packet format used within the connection layer, e.g. Ethernet, to the format used within the server layer, e.g. Synchronous Optical Network (SONET)/SDH, Frame Relay, IP, Generic Routing Encapsulation (GRE), Asynchronous Transfer Mode (ATM), or Ethernet. The termination function 114 monitors the transport of the server layer information between the adaptation functions 112 via the network connections 116. The network connections 116 may be one or a plurality of links or connections that transport the server information using the server layer's format, and carry the component connections described herein. The network connections 116 may also carry other link connections supporting other connections or composite connections. Finally, the network 100 may also be configured such that the components within the server layer, such as the termination function 114, are able to provide connectivity status messages to the components in the connection layer, such as the LPs 102.

As shown in FIG. 1B, the LPs 102 maybe coupled to the adaptation functions 112 via individual component link connections in component links 118, creating a composite link 120 comprising a plurality of component links, or combinations thereof As used herein, the term “component link” refers to a single point-to-point link coupling two devices, components, or functions. In contrast, the term “composite link” refers to a plurality of component links that exist in parallel between two devices. Each component link 118 is an independent transport entity, provides a set of link connections that preserve the order of packets transported therein, and has independent transport availability. When a composite connection 104 is transported over a composite link 120, the ingress LP 102a may distribute the component communications over the component links 118, using one link connection in each component link in a similar manner as they distribute the component communications over the component connections 110. The component links 118 may be dedicated to the use of the composite connection 104, or may be used by other resources using other link connections in each component link, such as other composite connections traversing the network.

FIG. 1C illustrates a third embodiment of the network 100 where the composite connection 104 comprises a plurality of monitored subnetwork connections 122. The monitored subnetwork connections 122 may comprise a subnetwork connection 110, which is substantially similar to the component connections 110 described above. The subnetwork connection 110 may extend between a plurality of OAM modules 124, which are substantially similar to the OAM module 106 described above, and may operate in the same layer as the composite connection 104. The OAM modules may monitor the connectivity of the component connections 110 and produce connectivity status messages. The subnetwork connections 110 may be dedicated to the use of the composite connection 104. As shown in FIG. 1C, the LPs 102 may be coupled to OAM modules 124 via individual component link connections in component links 118, creating a composite link 120 comprising a plurality of component links 118, or combinations thereof. The network 100 may also be configured such that the components within the monitored subnetwork, such as the OAM modules 124, are able to provide connectivity status messages to components outside of the subnetwork, such as the LPs 102.

FIG. 2 illustrates an example of a Component Communications Mapping (CCM) table 200. The CCM table 200 is used by the ingress LP to identify and forward packets to the proper component connection, and may comprise the CDFP values 202, the rate 204, and the component connection 206. The CDFP values 202 identify the CDFPs associated with the component communications that are being transported by the composite connection. The CDFP values 202 may also be used to identify the queuing or scheduling priority associated with the component communications. Specifically, particular CDFP values 202 may allow some packets to receive different queuing or scheduling treatment than other packets. The rate 204 indicates the bandwidth or other resource requirements for each component communication identified by a CDFP value 202. The component connection 206 indicates the component connection upon which the packets associated with the component communication identified by a CDFP 202 are sent. In case of a fault or partial fault (a capacity reduction) of any of the component connections, the CCM table 200 can also be used by the LPs to determine a suitable redistribution of component communications over the remaining available component connections. Such a feature is described in detail in U.S. patent application Ser. No. 11/769,534 filed Jun. 27, 2007 by Yong, et al. and entitled, “Network Availability Enhancement Technique in Packet Transport Networks” (the '534 application).

In some embodiments, the functions and tables described herein may be combined with similar functions or tables to create a single compound forwarding behavior. For example, the CCM table 200 can be combined with the tables described in the '534 application to provide a finer granularity distribution and recovery functionality. The CCM table 200 may also be combined with the normal connection forwarding function in a switch to support normal forwarding and composite connection distribution functions in a single component. This combination could include using the CDFP as an extension to the normal forwarding lookup key.

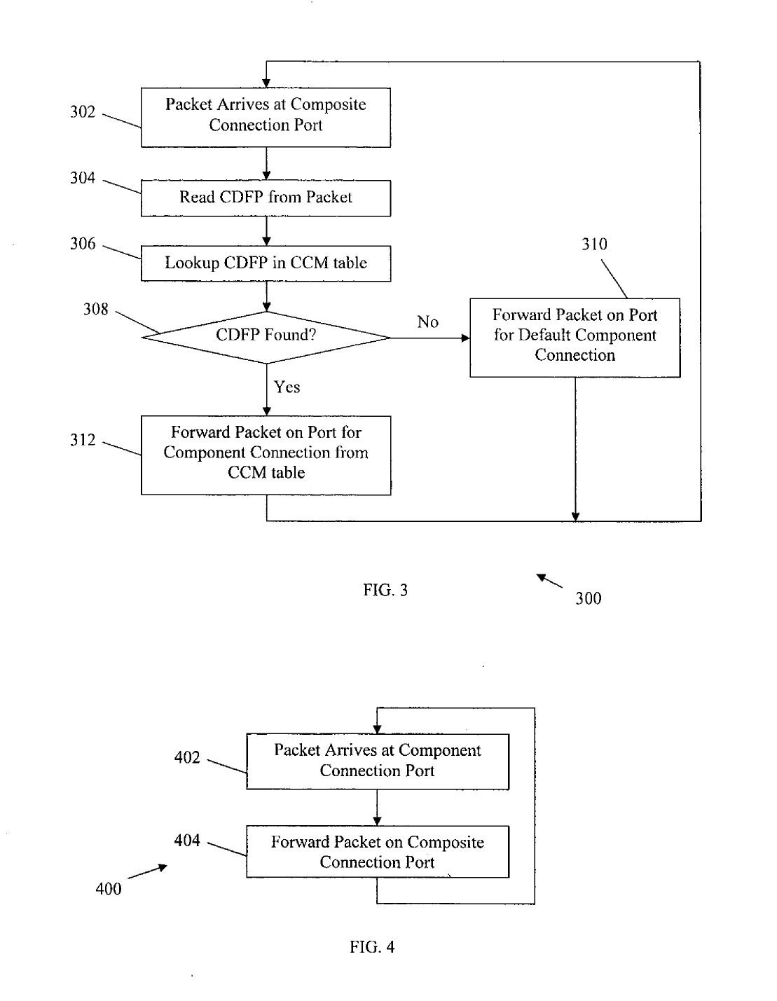

FIG. 3 is a flowchart of an embodiment of a composite connection ingress process 300. The process 300 may be implemented by the ingress LP. The process 300 begins at 302 where a packet is received at the ingress point of the composite connection. At 304, the CDFP in the packet is read. At 306, the CDFP is compared with the entries in the CCM table. At 308, the process determines whether there is an entry in the CCM table for the packet's CDFP value. If there is an entry in the CCM table for the packet's CDFP value, then the packet is sent to the port for the component connection associated with the CDFP at 312. If there is not an entry in the CCM table for the packet's CDFP, then the packet is sent to the port for a default component connection at 310. In an alternative embodiment, a policy may be created that all component communications must have a CDFP identified in the CCM table. In such an embodiment, packets whose CDFP value does not match an entry in the CCM table may be dropped or provided for analysis by a network operator. After the packet is forwarded at 310 or 312, the process 300 returns to block 302. By implementing the process 300, the network may improve transport quality for the component communications and optimize resource utilization.

FIG. 4 is a flowchart of an embodiment of a composite connection egress process 400. The process 400 may be implemented by the egress LP. The process begins at 402 where a packet is received at the egress point of a component connection. At 404, the packet is forwarded to the port associated with the composite connection. Generally, there is only a single composite connection egress port associated with each component connection egress port, and thus the forwarding logic is straightforward. If the ability to track which component communications came from each component connection is desired, a mapping table similar to the CCM table described above may be used. After the packet is forwarded at 404, the process 400 returns to 402.

The concepts described herein may also be applied to shared forwarding traffic engineering technologies such as PBB-TE being developed for IEEE 802.1. In this case, a component connection can be shared by packets belonging to multiple composite connections, according to the shared forwarding method. Sharing would normally be done in cases in which the composite connections sharing a component connection are to follow the same route to a common destination. However, the concepts described herein can also be used to separate connections previously merged by shared forwarding. Specifically, the CDFP may be used to distinguish the original component communications and to distribute the component communications to different component connections that follow different routes. This could enable traffic-engineered connections to merge in one domain, and then be separated to different routes in a subsequent domain. Thus, the concepts described herein may be used to provide independent traffic engineering in each domain.

There may be many advantages associated with the concepts described herein. For example, the distribution of the composite communication across the various component connections reduces the probability of congestion occurring at any given resource input. Furthermore, the distribution of the composite communication across the various component connections provides improved resilience as it is unlikely that more than one resource may fail at any given time. In addition, the distribution of the composite communication across the various component connections means that less traffic within the composite communication is affected by a given resource fault, which reduces the amount of that composite communication's traffic that must be rerouted to recover service connectivity. Furthermore, if all the packets belonging to a connection traverse a single link or connection, the CDFP may be used to distinguish component communications that require low delay from those that are not as delay sensitive. Such allows appropriate queuing and scheduling mechanisms to be applied to minimize the delay experienced by the delay sensitive packets.

The systems and method described herein may be preferred over content unaware connection transport systems and content-based connectionless transport systems. The concepts described herein allow traffic to be distributed over several paths across the network, enabling both load balancing and rapid fault recovery through local action at the composite connection endpoints. Content unaware connections follow a single path, and thus fault recovery usually requires repair of the fault or switching the entire connection to a different path. Connectionless transport systems do not generally allow for fault recovery via local action, and do not normally allow bandwidth to be reserved within the network or support traffic engineering. In addition, conventional traffic engineering is limited to route selection and bandwidth allocation. In contrast, the concepts described herein allow more sophisticated traffic engineering by allocating the composite communication to be distributed over the various component connections while maintaining the QoS of the component communications and thus the QoS of the composite communication as a whole. The more sophisticated traffic engineering allows the network to achieve better transport quality and more efficient resource allocation. In the case of dynamic component communications, creating dynamic or bandwidth variable component communications, the network may include some form of admission control or traffic planning to improve the resource allocation within the network.

The systems and method described herein may also be used for congestion management. When a component connection detects a pre-congestion condition, the component connection may send a pre-congestion notification message to the ingress LP. The pre-congestion condition may be based on the bandwidth, queue condition, delay variance, and so forth. Upon receipt of the pre-congestion message, the ingress LP may drop or reroute some packets of lesser importance. If the network is aware of individual component communication bandwidth, the ingress LP may also use that information to shutdown individual component communications and relieve the congestion condition.

The systems and method described herein may also be used for component communication-specific processing. If the network is aware of the bandwidth allocated to each component communications, the network may assign resources based on such knowledge. Thus, each component communication will receive its guaranteed transport resources. When there is unassigned capacity in a component connection, the network may leave the unassigned capacity idle or use the unassigned capacity to transport any queued packets from a component communication, for example, when a component communication exceeds its reserved bandwidth.

The systems and method described herein may also be used for partial fault management. As described above, a partial fault occurs when a connection's transport capacity is reduced, but not eliminated. When a partial fault occurs, the network may reduce the data transported over the connection using the knowledge of the component communications. Specifically, the ingress LP may choose specific component communications to transport using the component connection having the partial fault, and drop any remaining component communications or move such to other component connections.

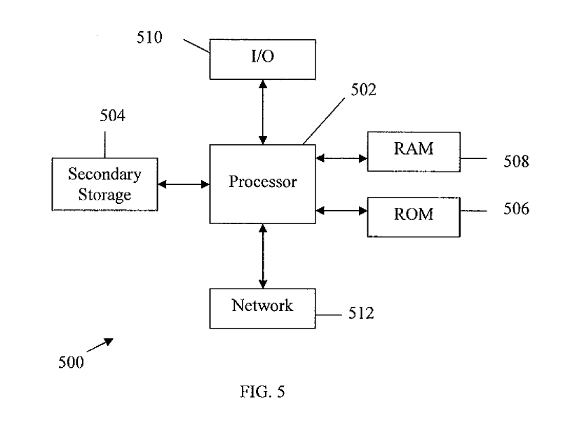

The network described above may be implemented on any general-purpose network component, such as a computer or network component with sufficient processing power, memory resources, and network throughput capability to handle the necessary workload placed upon it. FIG. 5 illustrates a typical, general-purpose network component suitable for implementing one or more embodiments of a node disclosed herein. The network component 500 includes a processor 502 (which may be referred to as a central processor unit or CPU) that is in communication with memory devices including secondary storage 504, read only memory (ROM) 506, random access memory (RAM) 508, input/output (I/O) devices 510, and network connectivity devices 512. The processor may be implemented as one or more CPU chips, or may be part of one or more application specific integrated circuits (ASICs).

The secondary storage 504 is typically comprised of one or more disk drives or tape drives and is used for non-volatile storage of data and as an over-flow data storage device if RAM 508 is not large enough to hold all working data. Secondary storage 504 may be used to store programs that are loaded into RAM 508 when such programs are selected for execution. The ROM 506 is used to store instructions and perhaps data that are read during program execution. ROM 506 is a non-volatile memory device that typically has a small memory capacity relative to the larger memory capacity of secondary storage. The RAM 508 is used to store volatile data and perhaps to store instructions. Access to both ROM 506 and RAM 508 is typically faster than to secondary storage 504.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A network comprising:
an ingress layer processor (LP) coupled to a connection carrying a composite communication comprising a plurality of component communications;
a composite connection coupled to the ingress LP and comprising a plurality of parallel component connections, wherein the composite connection is configured to transport the component communications using the component connections; and
an egress LP coupled to the composite connection and configured to transmit the composite communication at a connection point.

2. The network of claim 1, wherein the ingress LP is located at a first edge node and the egress LP is located at a second edge node.

3. The network of claim 1, wherein the ingress LP comprises a table that correlates at least some of the component communications with the component connections.

4. The network of claim 1, wherein the component communications are transported on the component connections such that a packet order in each component communication is maintained.

5. The network of claim 1, wherein at least one of the component connections comprises a sequence of link connections, fixed subnetwork connections, or both.

6. The network of claim 1, wherein at least one of the component connections comprises an adaptation function and a termination function at each end of a server layer network connection.

7. The network of claim 6, wherein the connection carrying the composite communication is received by the ingress LP in a first format, and wherein the network connection transports the component communication in a second format.

8. The network of claim 1, wherein at least part of at least one of the component connections comprises a second composite connection.

9. The network of claim 1, wherein at least one component communication carried by a first component connection is moved to a second component connection when the first component connection fails or partially fails.

10. The network of claim 1, wherein at least one of the component connections comprises a monitored subnetwork connection.

11. A network component comprising:
at least one processor configured to implement a method comprising:
receiving a connection carrying a plurality of component communications;
reading a communications distinguishing fixed point (CDFP) from at least some of the component communications; and
accessing a table associating at least some of CDFPs with at least one component connection.

12. The network component of claim 11, wherein the method further comprises promoting the transmission of the component communications on the component connections associated with the component communications' CDFPs for any component communications with CDFPs that are in the table.

13. The network component of claim 11, wherein the method further comprises promoting the transmission of the component communications on a default component connection for any component communications with CDFPs that are not in the table.

14. The network component of claim 11, wherein the method further comprises dropping any component communications with CDFPs that are not in the table.

15. The network component of claim 11, wherein the component communications are received on a connection port associated with a composite connection, and wherein the composite connection comprises the component connections.

16. The network component of claim 11, wherein the CDFP is present in the component communications when the component communications are received by the network.

17. The network component of claim 11, wherein the method further comprises adding the CDFP to at least some of the component communications.

18. The network component of claim 11, wherein the CDFP is a service instance identifier, a sender identifier, a receiver identifier, a traffic class identifier, a packet quality of service level identifier, a packet type identifier, a pseudowire identifier, an Ethernet backbone service instance identifier (I-SID), an Internet Protocol version 6 (IPv6) flow label, or combinations thereof.

19. A method comprising:
receiving a connection carrying a composite communication comprising a plurality of component communications comprising a plurality of packets;
interpreting information encoded in the packets; and
promoting the transmission of the composite communication on a composite connection comprising a plurality of parallel component connections,
wherein the component communications are transported on the component connections such that the order of packets in each component communication is maintained, and
wherein the composite communication is transported on the composite connection such that the order of packets belonging to different component communications in the composite communications is not necessarily maintained.

20. The method of claim 19, further comprising accessing a table that correlates the information encoded in a packet with a component connection assigned to carry the packet.
